(19) United States
(12) Patent Application Publication
(10) Pub. No.: US 2026/0330226 A1
(43) Pub. Date: Oct. 22, 2026

(54) MEMRISTOR-BASED COMPUTING-IN-MEMORY SYSTEM AND ONLINE DEEP LEARNING METHOD

(71) Applicant: HUAZHONG UNIVERSITY OF SCIENCE AND TECHNOLOGY, Hubei (CN)

(72) Inventors: Dan FENG, Hubei (CN); Wei TONG, Hubei (CN); Heng ZHOU, Hubei (CN); Bing WU, Hubei (CN); Huan CHENG, Hubei (CN); Wei ZHAO, Hubei (CN); Xueliang WEI, Hubei (CN); Jinpeng LIU, Hubei (CN); Yibo LIU, Hubei (CN)

(73) Assignee: HUAZHONG UNIVERSITY OF SCIENCE AND TECHNOLOGY, Hubei (CN)

(21) Appl. No.: 19/105,817

(22) PCT Filed: Jan. 3, 2024
(86) PCT No.: PCT/CN2024/070448

§ 371 Date: Feb. 24, 2025

(30) Foreign Application Priority Data
Feb. 27, 2023 (CN) 202310170150.6

(51) Int. Cl. G06N 3/084; G06N 3/063

(52) U.S. Cl. CPC G06N 3/084; G06N 3/063

(57) ABSTRACT

The disclosure provides a memristor-based computing-in-memory system (MCIM), and an online deep learning method for lifespan improvement of the MCIM. The MCIM comprises a storage module and a controller. The storage module comprises a plurality of Tiles, each Tile comprises a plurality of PEs, and each PE comprises one or more memristor arrays. A mapping table-based inter-crossbar wear-leveling scheme is executed in the controller, comprising: setting the interval between wear-leveling operations to every M write operation; maintaining metadata TWC and IWC for each PE, representing the total writes over the entire lifecycle and the total writes during the current interval; and circularly executing the following steps: setting the IWC of each PE to be 0; accumulating the number of writes into the corresponding IWC until the current interval ends; accumulating the IWC to the corresponding TWC; reconstructing the mapping table; performing data exchange based on the current mapping table.

### TECHNICAL FIELD

The present invention belongs to the field of information storage, and more specifically, relates to a computing in memory system based on a memristor and an online deep learning method.

### DESCRIPTION OF RELATED ART

With the advent of the big data era, the demands on computing speed, power consumption, and other aspects of conventional computing systems are increasing. The von Neumann problem has become an important bottleneck restricting the further development of current computer systems. Since its introduction, the memristor has become one of the most promising candidates for next-generation semiconductor memory due to its non-volatile, highly integrated, and low power consumption characteristics. The computing and storage integration feature of memristors also provides a powerful foundation for constructing new computing in memory architectures. Due to its high density and high energy efficiency, the memristor-based computing in memory architecture has shown great potential in applications such as deep neural network acceleration.

FIG. 1 shows a classic computing in memory neural network accelerator architecture based on a memristor, which adopts a 3-layer architecture design (Tile/PE/Crossbar). The storage structure includes multiple Tiles, each Tile further includes multiple PEs, and each PE contains multiple memristor arrays. The memristor units in the memristor array are often organized in the form of a crossbar array.

In large-scale streaming data scenarios represented by online deep learning, frequent writes to the memristor array occur, posing a significant challenge to the limited service life of the memristor array. Moreover, uneven writes may lead to a dramatic decrease in the service life of the computing in memory system based on the memristor, highlighting the “buckets effect”. Further, in the large-scale streaming data scenarios, the problem of uneven writes becomes even more prominent.

To address the impact of uneven writes on the service life of memristors, researchers have proposed corresponding wear-leveling strategies. The overall idea is to distribute writes as evenly as possible among different units. FIG. 2 is a schematic diagram illustrating execution of three intra-array wear-leveling strategies of the related art, where (a) is the column shift (CS) scheme, which achieves wear-leveling by cyclically shifting all columns within the array; (b) is the row swap (RS) scheme, which achieves wear-leveling by swapping matrix rows; and (c) is the row column swap (RCS) scheme, which achieves wear-leveling by swapping rows and columns within the array. These wear-leveling strategies may extend the array service life to some extent. However, existing wear-leveling strategies are all implemented within the array and cannot perform wear-leveling at the system level, and the service life improvement effect is thus limited.

### SUMMARY

In response to the deficiencies and improvement needs of the related art, the present invention provides a computing in memory system based on a memristor and an online deep learning method, aiming to improve the effect of wear-leveling in the computing in memory system based on the memristor, so as to increase the overall service life of the system.

To achieve the above, in one aspect of the present invention, a computing in memory system based on a memristor including a storage module and a controller is provided.

The storage module includes a plurality of interconnected Tiles, each Tile includes a plurality of interconnected PEs, and each PE includes N memristor arrays. A mapping relationship between a logical ID and a physical ID of each PE is recorded in a mapping table. N is a positive integer, and N≥1.

The controller is used for executing a mapping table-based cross-array wear-leveling strategy, including the following:

Every M writes is classified into one wear-leveling period, where M is a predetermined positive integer. Metadata TWC and IWC are maintained for each PE, which are used to record the total number of writes and the number of writes in the current wear-leveling period respectively for each PE, where the followings steps are executed in each wear-leveling period:

In (S1), IWC of each PE is set to 0.

In (S2), the number of writes of the memristor array in the PE at an operation stage is accumulated and recorded in the corresponding IWC until the current wear-leveling period ends.

In (S3), the IWC of each PE is accumulated to the corresponding TWC.

In (S4), the mapping table is reconstructed, so that the larger the IWC is, the smaller the TWC corresponding to a physical ID mapped by a corresponding logical ID is.

In (S5), data exchanged is carried out on the data stored in the PE based on the current mapping table.

Further, N=1.

Further, the IWC of each PE is stored in a register inside the memristor array thereof.

Further, the plurality of Tiles in the storage module are interconnected through Torus routing.

Further, one or more memristor arrays in the storage module are divided into dedicated metadata storage zones.

Further, the TWC of each PE is stored in the metadata storage zone.

According to another aspect of the present invention, an online deep learning method based on the computing in memory system based on the memristor provided in the present invention is provided, where the computing in memory system based on the memristor is used to accelerate online deep learning.

The online deep learning method includes the following steps.

In a back-propagation process if a contribution rate αₖ of any k^{th} hidden layer is less than a predetermined threshold ε and the number of data instances since the last update of a weight Wₖ of the hidden layer is less than a predetermined value γ, the weight Wₖ of the hidden layer is not updated; otherwise, the weight Wₖ of the hidden layer is updated.

Further, the online deep learning method provided by the present invention further include the following step. The weight of the hidden layer and step (S5) are updated and executed simultaneously.

Further, γ=2.

Further, the computing in memory system based on the memristor further includes an auxiliary computing unit for performing a vector operation.

Further, during the back-propagation process of the online deep learning method, calculation of a weight gradient is completed by the auxiliary computing unit.

Further, the computing in memory system based on the memristor further includes: a global cache.

Further, during the back-propagation process of the online deep learning method, intermediate data required for the weight gradient calculation is stored in the global cache.

In general, the above technical solutions provided by the present invention have the following beneficial effects:

(1) The computing in memory system based on the memristor provided by the present invention adopts the mapping table-based cross-array wear-leveling strategy. This strategy maintains metadata TWC and IWC for each PE. TWC is used to record the total number of writes of the PE, reflecting the overall wear degree of the arrays within it throughout their entire life cycle. IWC is used to record the number of writes in the current wear-leveling period, reflecting the short-term write intensity of the arrays within it. At the end of each wear-leveling period, the mapping table is rebuilt, so that the larger the IWC, the smaller the TWC corresponding to the physical ID mapped by the corresponding logical ID. This remaps the “hot” logical arrays to less worn physical arrays, wear-leveling across arrays is thus achieved. Compared with intra-array wear-leveling methods of the related art, the effect of wear-leveling is improved, and the overall service life of the system can be ultimately increased.

The mapping table-based cross-array wear-leveling strategy is orthogonal to intra-array wear-leveling strategies of the related art and can be used in combination with the intra-array wear-leveling strategies of the related art. This allows for intra-array wear-leveling on the basis of cross-array wear-leveling, so the wear-leveling effect is further improved.

In addition, the mapping table-based cross-array wear-leveling strategy can cause physical arrays belonging to the same logical matrix to be distributed across multiple Tiles after reconstructing the mapping table, so computational tasks are dispersed across multiple Tiles, and bandwidth contention within Tiles is thus alleviated.

(2) In the computing in memory system based on the memristor provided by the present invention, in the preferred scheme, each PE contains only a single memristor array. This is equivalent to removing the PE level from the original three-level (Tile/PE/Crossbar) architecture. The system architecture is simplified from a three-level (Tile/PE/Crossbar) hierarchy to a two-level (Tile/Crossbar) hierarchy. Unnecessary communication overhead is thereby reduced, computation speed is accelerated, and the overall performance of the system is further improved.

(3) In the present invention, IWC is temporary metadata and is frequently updated. In the preferred scheme of the present invention, under the two-level hierarchy, IWC is stored in registers within the memristor array. This avoids frequent writes to the memristor array due to IWC updates.

(4) In the preferred scheme of the present invention, under the two-level hierarchy, the plurality of Tiles in the storage module are interconnected through Torus routing, which can further reduce communication overhead.

(5) In the present invention, TWC is important metadata that records the total number of writes to units within the memristor array throughout its life cycle. In the preferred scheme of the present invention, the metadata TWC of each PE is centrally stored in a dedicated memristor array, so that non-volatile storage of the metadata TWC is achieved, and the storage security of the metadata TWC is ensured.

(6) In the online deep learning method provided by the present invention, a deep learning network is implemented using the computing in memory system based on the memristor provided by the present invention. By updating only the weights of hidden layers with higher contribution rates during the back-propagation process, and not updating the weights of non-critical hidden layers, while forcibly updating the hidden layer weights every γ data instances, this method effectively reduces the number of hidden layer weight updates while ensuring the effectiveness of deep learning. In this way, the number of writes to arrays is reduced in the computing in memory system, energy consumption is lowered, and the system service life is extended in turn.

(7) In the preferred scheme of the online deep learning method provided by the present invention, when executing the data exchange operation in the mapping table-based cross-array wear-leveling strategy, the hidden layer weights are updated simultaneously. Since the data exchange is hidden within the weight update, the additional writes introduced by data exchange are reduced through overlapping data exchange and weight updates in the present invention.

(8) In the online deep learning method provided by the present invention, in the preferred scheme, the number of data instances between forced weight updates is specifically set to γ=2, so that the maximum balance between deep learning effectiveness and the improvement of memristor array service life can be achieved.

(9) The data relied upon by online deep learning is large-scale streaming data. In the back-propagation process, the matrix operations for gradient calculation degrade to vector operations. In the preferred scheme of the present invention, by transferring the calculation of the weight gradient from the memristor array to the auxiliary computing unit, the writing to the memristor array may be reduced, energy costs are lowered, service life is increased, and waste of space is avoided.

(10) In deep learning, the calculation of weight gradients requires intermediate data as input. In online deep learning, the storage requirement for intermediate data is relatively small. In the preferred scheme of the present invention, the storage location of intermediate data required for weight gradient calculation is transferred from the memristor array to the global cache, so that waste of space can be avoided.

### BRIEF DESCRIPTION OF THE DRAWINGS

FIG. 1 is a diagram of an architecture of a computing in memory system based on a memristor of the related art.

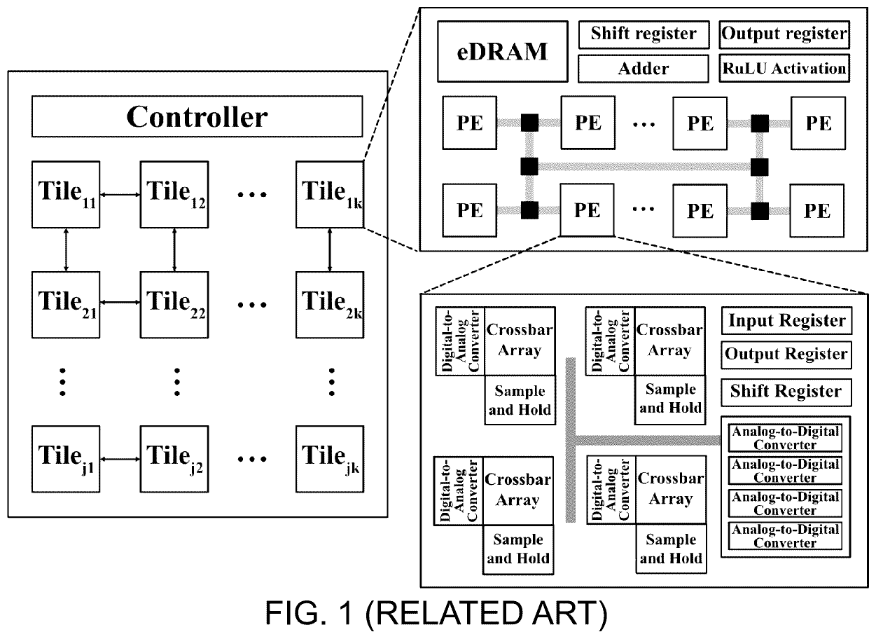

FIG. 2 is a schematic diagram of execution of three intra-array wear-leveling strategies of the related art, where (a) is a column shift (CS) scheme, (b) is a row swap (RS) scheme, and (c) is a row column swap (RCS) scheme.

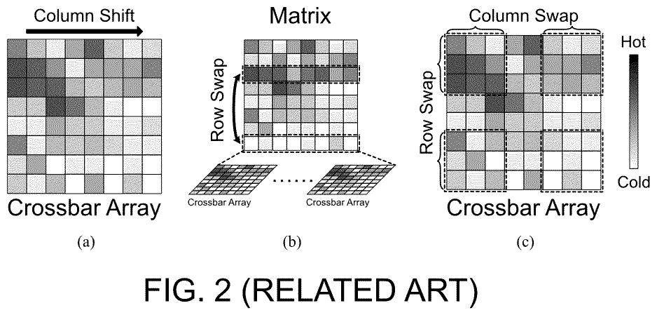

FIG. 3 is a schematic diagram of a computing in memory system based on a memristor provided by an embodiment of the present invention.

FIG. 4 is a flow chart of a mapping table-based cross-array wear-leveling strategy provided by an embodiment of the present invention.

FIG. 5 is a schematic diagram of the mapping table-based cross-array wear-leveling strategy provided by an embodiment of the present invention.

FIG. 6 is a schematic diagram of an HBP online deep learning network structure of the related art, where (a) is a forward-propagation process, and (b) is a back-propagation process.

### DESCRIPTION OF THE EMBODIMENTS

In order to make the objectives, technical solutions, and advantages of the present invention clearer and more comprehensible, the present invention is further described in detail with reference to the drawings and embodiments. It should be understood that the specific embodiments described herein serve to explain the present invention merely and are not used to limit the present invention. In addition, the technical features involved in the various embodiments of the invention described below can be combined with each other as long as the technical features do not conflict with each other.

In the present invention, the terms “first”, “second”, and the like (if any) in the present invention and the accompanying drawings are used to distinguish similar objects, and are not necessarily used to describe a specific order or sequence.

To address the technical problem of poor effectiveness in improving the overall service life of a computing in memory system based on a memristor when using the intra-array wear-leveling methods of the related art, the present invention provides a computing in memory system based on a memristor. Its overall approach lies in that the wear-leveling algorithm is improved, “hot” logical arrays are periodically remapped to less worn physical arrays to achieve cross-array wear-leveling, and the overall service life of the system is thus ultimately improved. On this basis, an online deep learning method is provided. The overall approach lies in that writes to the memristor array is reduced without affecting the effectiveness of online deep learning, so as to address the defects of frequent weight update writes and unbalanced writes leading to low system service life faced by online deep learning in a computing in memory system based on a memristor.

Embodiments are provided as follows:

### Embodiment 1

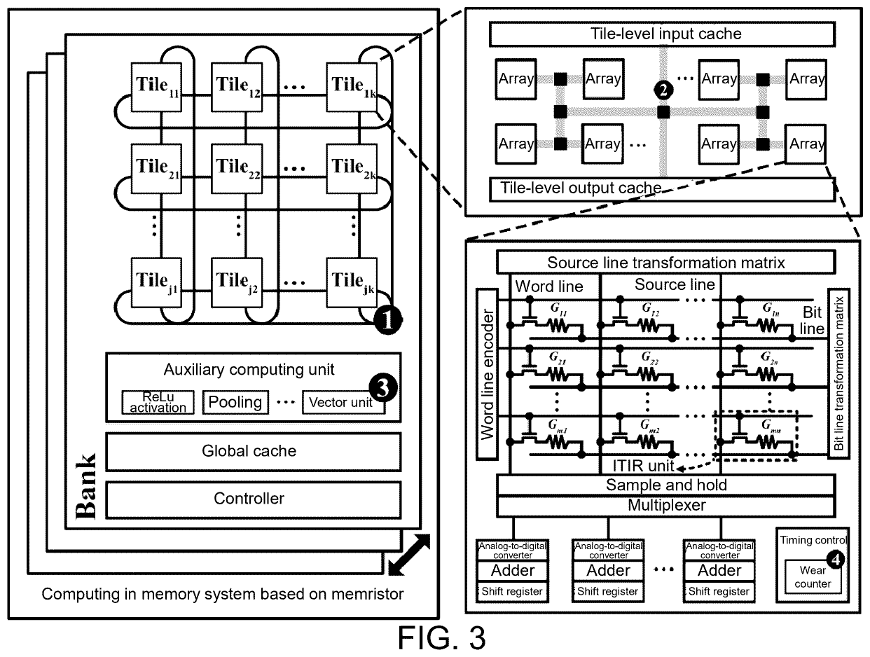

A computing in memory system based on a memristor, as shown in FIG. 3, includes: a storage module and a controller.

The storage module includes a plurality of interconnected Tiles, each Tile includes a plurality of interconnected PEs, and each PE includes N memristor arrays. A mapping relationship between a logical ID and a physical ID of each PE is recorded in a mapping table. The logical ID is a virtual reference assigned by the system to upper-layer applications for accessing physical arrays, and the physical ID uniquely represents the PE in the computing in memory system.

As shown in FIG. 3, in this embodiment, each PE includes only a single memristor array, i.e., N=1. Therefore, the computing in memory system based on the memristor provided in this embodiment is equivalent to removing the PE level from the original three-level (Tile/PE/Crossbar) architecture. The system architecture is simplified from the conventional three-level (Tile/PE/Crossbar) hierarchy to a two-level (Tile/Crossbar) hierarchy. Unnecessary communication overhead is thereby reduced, and computation speed is accelerated. Moreover, to further reduce communication overhead, in this embodiment, the plurality of Tiles are interconnected through Torus routing. It should be noted that the interconnection method of Tiles herein is only a preferred implementation and should not be understood as the sole limitation of the present invention. Other interconnection methods, such as Mesh, may also be used for the present invention.

As shown in FIG. 3, in this embodiment, each Tile consists of multiple memristor arrays and tile-level input/output buffer zones and is interconnected through H-Tree.

As shown in FIG. 3, the memristor units in each memristor array are connected in the form of a Crossbar, i.e., a crossbar array. Optionally, in this embodiment, in order to reduce the impact of write disturbance and sneak current, the memristor units in the memristor array are 1T1R units.

In this embodiment, the controller is used for executing a mapping table-based cross-array wear-leveling strategy (table-based inter-crossbar wear-leveling, TIWL), and the strategy includes the following.

Every M writes is classified into one wear-leveling period, where M is a predetermined positive integer that can be determined according to actual needs. Metadata TWC and IWC are maintained for each PE, which are used to record the total number of writes and the number of writes in the current wear-leveling period respectively for each PE. Since in this embodiment, each PE contains only 1 memristor array, the maintained TWC and IWC are the TWC and IWC of each memristor array.

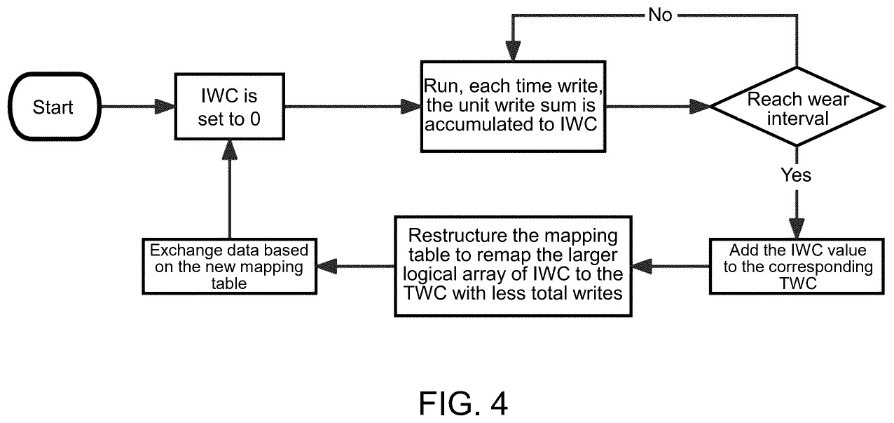

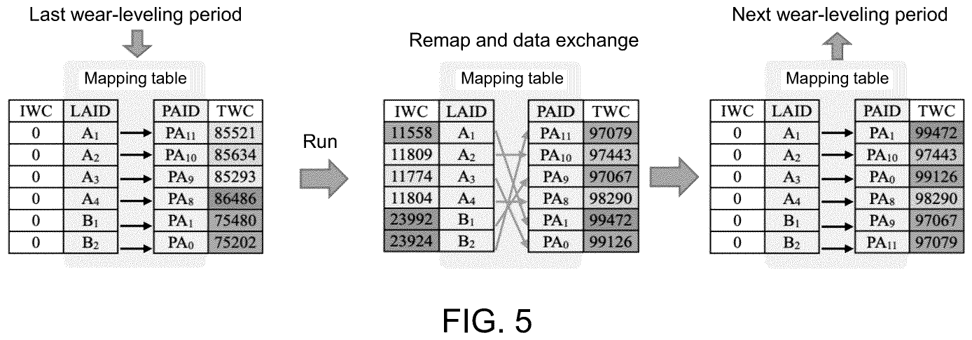

As shown in FIG. 4 and FIG. 5, TIWL executes the following steps in each wear-leveling period:

In (S1), IWC of each PE is set to 0.

In (S2), the number of writes of the memristor array in the PE at an operation stage is accumulated and recorded in the corresponding IWC until the current wear-leveling period ends.

In (S3), the IWC of each PE is accumulated to the corresponding TWC.

In (S4), the mapping table is reconstructed, so that the larger the IWC is, the smaller the TWC corresponding to a physical ID mapped by a corresponding logical ID is.

Similarly, each PE contains only 1 memristor array, and the logical ID and the physical ID of the PE are the logical ID and the physical ID of the memristor array, respectively.

IWC reflects the short-term write intensity of the memristor array, while TWC reflects the total wear degree of the memristor array throughout its service life. In this embodiment, system-level wear-leveling, namely cross-array wear-leveling, is implemented by reconstructing the mapping table to remap “hot” logical arrays to less worn physical arrays. Compared to the intra-array wear-leveling of the related art, this approach achieves improved wear-leveling effects and may effectively extend the overall service life of the system.

In (S5), data exchange is carried out on the data stored in the PE based on the current mapping table.

During the process of reconstructing the mapping table, the mapping relationship between the logical ID and the physical ID may change. For the physical ID whose mapping relationship is changed, it is necessary to exchange the data stored in the corresponding memristor array to ensure the correctness of the mapping relationship.

IWC is temporary metadata and is frequently updated. To avoid introducing frequent writes to the memristor array due to IWC updates, as a preferred implementation, in this embodiment, the IWC is recorded in registers within each memristor array, namely the “wear counter” in FIG. 3. TWC is important metadata that records the total number of unit writes during the service life of the memristor array and requires non-volatile storage media for storage. To ensure the storage safety of TWC, in this embodiment, one or more memristor arrays in the storage module are divided into dedicated metadata storage zones.

Further, the TWC of each PE is stored in the metadata storage zone.

Compared to intra-array wear-leveling methods, TIWL does not need to record the aging state of each word line or bit line, nor does it need to obtain the temperature of each unit. Therefore, storage and computation costs are reduced. A brief analysis of the related costs is as follows:

Assuming IWC and TWC are 32-bit and 64-bit respectively, and 128×128 arrays are used to build a 4 GB computing in memory system based on a memristor. The wear metadata occupies 24 MB (0.59% of 4 GB), and the mapping table occupies 16 MB (0.15% of 4 GB), which is within an acceptable range of storage overhead. When the array size increases to 512×512, the storage overhead for wear metadata and mapping table decreases to 1.14 MB (0.03% of 4 GB) and 1.5 MB (0.04% of 4 GB) respectively. The metadata for each array is fixed at 96-bit, which is far less than the intra-array wear-leveling strategy of the related art—row swapping strategy (N×T, where N represents the number of rows and T is the bit width of the register).

Overall, in the computing in memory system based on the memristor provided in this embodiment, the adopted mapping table-based cross-array wear-leveling strategy (TIWL), can remap the “hot” logical arrays to less worn physical arrays, and wear-leveling across arrays is thereby achieved. Compared with intra-array wear-leveling methods of the related art, the effect of wear-leveling is improved, and the overall service life of the system can be ultimately increased. Moreover, the mapping table-based cross-array wear-leveling strategy provided in this embodiment is orthogonal to intra-array wear-leveling strategies of the related art and can be used in combination with the intra-array wear-leveling strategies of the related art. This allows for intra-array wear-leveling on the basis of cross-array wear-leveling, so the wear-leveling effect is further improved. Additionally, the mapping table-based cross-array wear-leveling strategy may cause physical arrays belonging to the same logical matrix to be distributed across multiple Tiles after reconstructing the mapping table, so computational tasks are dispersed across multiple Tiles, and bandwidth contention within Tiles is thus alleviated.

It should be noted that the mapping table-based cross-array wear-leveling strategy (TIWL) provided in this embodiment, while improving the wear-leveling effect, may introduce additional communication overhead as computational tasks are dispersed across multiple Tiles. However, this communication overhead is within an acceptable range. Moreover, in this embodiment, the communication overhead brought by TIWL can be effectively alleviated through optimization of the system architecture and Tile interconnection method. Overall, in terms of enhancing the overall service life of the computing in memory system based on the memristor, in this embodiment, significant benefits can be achieved with minimal overhead.

It is easily understood that the above two-level (Tile/Crossbar) hierarchical architecture is only a preferred embodiment of the present invention and should not be construed as the sole limitation of the present invention. TIWL may achieve an architecture-friendly balance between mapping overhead and mapping benefits by adjusting the scheduling granularity (i.e., PE size). When the number of memristor arrays contained in a PE is greater than 1, the implementation of TIWL in the computing in memory architecture is similar to the process described above. The difference lies in that after reconstructing the mapping table to determine the mapping relationship between the logical ID and physical ID of the PE, it is also necessary to complete the remapping of the logical ID to physical ID of the memristor arrays according to the order of memristor arrays within the PE. In addition, the metadata IWC of the PE is shared by multiple memristor arrays within it and needs to be stored in the register corresponding to the PE.

It is equally easy to understand that in this embodiment, the implementation of TIWL does not depend on the specific internal structure of the Tile. When the internal structure of the Tile changes, for example, when the memristor unit changes, the overall service life of the computing in memory system based on the memristor provided by the present invention can still be effectively improved.

### Embodiment 2

An online deep learning method based on the computing in memory system based on the memristor provided in the above Embodiment 1 is provided, where the computing in memory system based on the memristor is used to accelerate online deep learning.

Before the technical solution of this embodiment is explained in detail, a brief introduction to the online deep learning method of the related art is provided as follows:

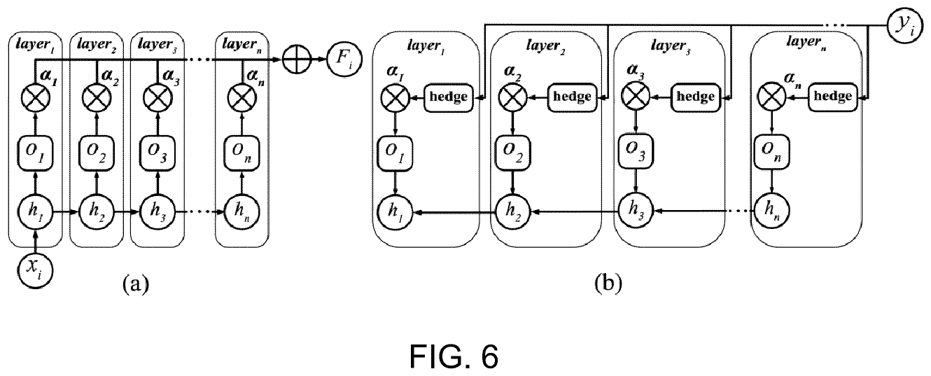

Online deep learning can learn from streaming data and keep the model continuously trained and evolved. Compared with offline batch training, it can better learn in streaming data scenarios. FIG. 6 is a schematic diagram of a classic HBP online deep learning network structure, where (a) is a forward-propagation process, and (b) is a back-propagation process. The online deep learning network structure consists of two parts: one part is a hidden layer h, and the hidden layer is the same as the deep neural network in conventional offline learning, propagating layer by layer from the first layer; and the other part is an output layer o, where each output layer is connected to a Softmax classifier to evaluate the learning situation of the current hidden layer. In the figure, αₙ represents a contribution weight proportion of the n^{th} layer among all hidden layers, oₖ represents the Softmax output of the k^{th} layer classifier output layer, and hₖ represents the output of the k^{th} hidden layer after activation.

Assuming that the number of hidden layers in a deep neural network is N, the final output of the online deep learning HBP model can be represented by the following formula:

$$\begin{matrix}\begin{matrix}F ( x ) = {\sum }_{k = 1}^{N} {α}_{k} \cdot {o}_{k} , ∀ k = 1 , … , N , & where\end{matrix} \\ {o}_{k} = Softma x ( {h}_{k} \cdot {Θ}_{k} ) , ∀ k = 1 , … , N \\ {h}_{k} = σ ( {W}_{k} \cdot {h}_{k - 1} ) , ∀ l = 1 , … , L , and \\ {h}_{o} = x\end{matrix}$$

The HBP model needs to learn three parameters, which are Θₖ, Wₖ, and αₖ.

Herein, Θₖ represents the parameter weight of the k^{th} output layer, Wₖ represents the parameter weight of the k^{th} hidden layer, and αₖ controls the contribution weight proportion of each layer to the output. The classifier outputs of each layer are weighted and summed to obtain the final output result. The loss function of the model may be defined as:

$$ℒ ( F ( x ) , \hat{y} ) = {\sum }_{k = 1}^{N} {α}_{k} {ℒ}_{C E} ( {o}_{k} , \hat{y} ) ,$$

which is the weighted sum of the classifier loss functions for each layer.

The contribution weight proportion αₖ of each layer is initialized to a uniform distribution:

$${α}_{k} = \frac{1}{N + 1} , k = 1 , … , N .$$

During each iteration process, the output of each layer's classifier is oₖ, which is used to calculate the loss function with the true result. The contribution weight proportion αₖ of each layer is updated through the following formula:

$${α}_{k}^{t + 1} = {α}_{k}^{t} .$$

[symbol]

), where t represents the iteration round, and β∈(0,1) is the decay coefficient. The contribution weight proportion α^{(l)} of each layer may decay according to the loss function [symbol] after each iteration. After all contribution weight proportions are updated, they are normalized to ensure

$${\sum }_{k = 1}^{N} {α}_{k} = 1 .$$

For the weight Θₖ of the output layer, it is updated through the online gradient descent method, which is the same as conventional offline learning. The update process of weight Θₖ is shown as follows:

$${Θ}_{k}^{t + 1} = {Θ}_{k}^{t} - {α}_{k} η {∇}_{{Θ}_{k}^{t}} {ℒ}_{C E} ( {o}_{k} , \hat{y} )$$

For the update of hidden layer weight Wₖ, unlike the conventional back-propagation method, the error partial derivative is obtained by back-propagation from all output layers (i.e., each classifier oₖ). Therefore, the following formula is used to represent its update process:

$${W}_{k}^{t + 1} = {W}_{k}^{t} - η {\sum }_{i = k}^{N} {α}_{i} {∇}_{{w}_{i}^{t}} {ℒ}_{C E} ( {o}_{i} , \hat{y} ) ,$$

where

$${∇}_{{w}_{i}^{t}} {ℒ}_{C E} ( {o}_{i} , \hat{y} )$$

is obtained by error back-propagation from each classifier. It should be noted that the weight update of the k-h hidden layer requires the weighted accumulation of error partial derivatives from all subsequent hidden layers

$$( {\sum }_{i = k}^{N} {α}_{i} {∇}_{{w}_{i}^{t}} {ℒ}_{C E} ( {o}_{i} , \hat{y} ) ) .$$

Since the HBP optimization method reduces the weight proportion αₖ of deep networks to a very small value, in order to limit its impact on learning, a smoothing parameter s (s∈(0,1) is used to control the update of αₖ. After each weight update, it is corrected as follows:

$${α}_{k} = max ( {α}_{k} , \frac{s}{N} ) ,$$

to prevent deep networks from being unable to participate in the back-propagation process.

Online deep learning involves a large amount of matrix operations. Memristor arrays can accelerate matrix-vector multiplication operations, and deep learning applications contain numerous matrix-vector multiplication operations. Therefore, memristor arrays can be utilized for acceleration. More specific, the network weights W are stored in the array, the array input is a vector, and the array output is the computation result.

At present, the use of the computing in memory system based on the memristor to accelerate online deep learning still faces challenges. First, for online deep learning on large-scale streaming data, the number of weight updates (usually more than millions) is far greater than conventional offline batch training, which causes frequent writes to the memristor array, posing a significant challenge to the limited service life of the memristor array. Second, the uneven writing of the array during weight updates may lead to a sharp decrease in system service life, highlighting the “buckets effect”, and large-scale continuous training in online deep learning scenarios may make the problem of uneven writing more prominent.

In the online deep learning method provided in this embodiment, the computing in memory system based on the memristor described in the aforementioned Embodiment 1 is used to implement the deep learning network. Since this computing in memory system adopts a mapping table-based cross-array wear-leveling strategy, it can mitigate the impact of weight updates in the online deep learning method on system service life, even in the case of uneven array writing caused by weight updates, so that the effective implementation of the online deep learning method is ensured.

Considering that as training data is input, the contribution rate α of shallow networks gradually decreases, while the contribution rate of deep networks gradually increases, the training of online deep learning networks such as HBP starts from shallow neurons and then gradually trains neurons in deeper networks. The final result of the network is obtained by weighted summing of the classifiers of all layers according to the contribution rate α. The network layer with low a has less influence on the output of the network. Based on this consideration, in this embodiment, the weight update method in the back-propagation process of the online deep learning method is improved, and a write-optimized parameter update (WARP) strategy is provided. This strategy dynamically controls the weight update of hidden layers based on the weight proportion of network layers, so that unnecessary weight writes are avoided, and array wear is reduced.

More specifically, during each training iteration, if αₖ of the k^{th} hidden layer is less than a threshold ε (a predetermined constant, preferably 1/N), the contribution of this layer to the final output result of the network is also less. Therefore, the update of the weight Wₖ of this hidden layer is reduced. At the same time, considering that if the hidden layer weights are continuously not updated, it may lead to slow network convergence. To control the degree of reduced weight updates, the hidden layer weights are forcibly updated every γ data instances. This weight update process may be expressed as follows:

$$\{ \begin{matrix}{α}_{k} < ε , & reduce the update of {W}_{k} \\ {α}_{k} \geq ε , & {W}_{k} is updated normally\end{matrix}$$

Based on the above weight update method, in this embodiment, the number of hidden layer weight updates is effectively reduced while the deep learning effect is ensured. The writing to arrays in the computing in memory system is thereby reduced, energy consumption costs are lowered, and system service life is extended. As a preferred embodiment, in this embodiment, γ=2. Experiments show that setting the number of data instances between forced weight updates in this way can achieve the maximum balance between deep learning effect and the improvement of memristor array service life.

As a preferred embodiment, in this embodiment, the following is also included: the update of hidden layer weights is executed together with step (S5), that is, in the computing in memory system based on the memristor, the data exchange operation in TIWL. Since the data exchange is hidden in the weight update, the additional writes introduced by data exchange are reduced through overlapping data exchange and weight update in this embodiment, so that energy consumption is further decreased and system service life is increased.

In the online deep learning method, the calculation of weight gradient ∇W requires intermediate data x as input: ∇W₁=xₗ₋₁(δₗ)^{T}, so the forward stage needs to store x. In the computing in memory systems based on the memristors for the online deep learning methods of the related art, the main computation and storage are entrusted to memristor arrays. However, the use of memristors to calculate weight gradient ∇W may lead to two problems: (1) Frequent rewriting of memristor arrays may introduce energy costs and shorten service life. Moreover, in online deep learning based on large-scale streaming data, the matrix operations of gradient calculation may degrade to vector operations. Directly using memristor arrays to store vector data may also cause waste of memristor array space. (2) Storing striped intermediate data in memristor arrays may waste space and exacerbate wear imbalance. The storage of intermediate data for online deep learning is smaller compared to offline batch training. For instance, for training a 16-layer network (hidden layer size of 100) using HBP, only approximately 9 KB of storage is needed for intermediate data.

Therefore, as shown in FIG. 3, in this embodiment, an auxiliary compute unit (ACU) is further arranged in the computing in memory system based on the memristor, which is used to execute a vector operation. Further, in this embodiment, during the back-propagation process of the online deep learning method, the calculation of weight gradients is completed by the auxiliary computing unit. By transferring the calculation of the weight gradient from the memristor array to the auxiliary computing unit, the writing to the memristor array may be reduced, energy costs are lowered, service life is increased, and waste of space is avoided. Based on the same consideration, as an optional embodiment, in this embodiment, the auxiliary computing unit is also used to complete the processing of array results from different Tiles, including ReLU activation, pooling, and cumulative summation, etc.

In addition, in this embodiment, a global cache is further arranged in the computing in memory system based on the memristor, as shown in FIG. 3. Further, in this embodiment, the intermediate data required for weight gradient calculation is stored in the global cache. In this embodiment, by transferring the storage location of the intermediate data from the memristor array to the global cache, space waste can be avoided.

In view of the foregoing, in this embodiment, the online deep learning method based on the computing in memory system based on the memristor provided in the above Embodiment 1 is achieved. Through further improvements, the defects faced by online deep learning in the computing in memory architecture based on the memristor, such as frequent weight update writes and uneven writes leading to low system service life, can be overcome and solved.

A person having ordinary skill in the art should be able to easily understand that the above description is only preferred embodiments of the present invention and is not intended to limit the present invention. Any modifications, equivalent replacements, and modifications made without departing from the spirit and principles of the present invention should fall within the protection scope of the present invention.

1. A memristor-based computing-in-memory system, comprising: a storage module and a controller, wherein
the storage module comprises a plurality of interconnected Tiles, each Tile comprises a plurality of interconnected processing elements (abbreviated as PE), and each PE comprises N memristor arrays; a mapping relationship between a logical PE address (abbreviated as LAID) and a physical PE address (abbreviated as PAID) is recorded in a mapping table, N is a positive integer, and N≥1,
the controller is used for executing a mapping table-based inter-crossbar wear-leveling strategy, comprising:
setting the interval between wear-leveling operations to every M write operation, where M is a predetermined positive integer; maintaining metadata TWC and IWC for each PE, where TWC records the total number of writes for all cells throughout the entire lifecycle of the PE, and IWC records the cumulative number of writes for all cells during the current wear-leveling interval of the PE, wherein the followings steps are executed in each wear-leveling interval:
(S1) setting the IWC of each PE to 0;
(S2) accumulating the number of writes of the array within each PE into the IWC of its corresponding PE during the running stage until the current wear-leveling interval ends;
(S3) accumulating the IWC of each PE to the corresponding TWC;
(S4) reconstructing the mapping table, so that a LAID with a larger IWC is mapped to a PAID with a smaller TWC; and
(S5) performing data exchange between PEs based on the current mapping table.

2. The memristor-based computing-in-memory system according to claim 1, wherein N=1.

3. The memristor-based computing-in-memory system according to claim 2, wherein the IWC of each PE is stored in a register inside the array thereof.

4. The memristor-based computing-in-memory system according to claim 2, wherein the plurality of Tiles in the storage module are interconnected through Torus routing.

5. The memristor-based computing-in-memory system according to claim 1, wherein one or more memristor arrays in the storage module are designated as the dedicated metadata storage zone, and
the TWC of each PE is stored in the metadata storage zone.

6. An online deep learning method for extending the lifespan of memristor-based computing-in-memory system according to claim 1, wherein the memristor-based computing-in-memory system is used for accelerating online deep learning,
the online deep learning method comprises:
in the back-propagation process of online deep learning if a contribution rate αₖ of any k^{th} hidden layer is less than a predetermined threshold ε and the number of data instances since the last update of a weight Wₖ of the hidden layer is less than a predetermined value γ, not updating the weight Wₖ of the hidden layer; otherwise, updating the weight Wₖ of the hidden layer.

7. The online deep learning method according to claim 6, further comprises: updating the weight of the hidden layer and executing step (S5) simultaneously.

8. The online deep learning method according to claim 6, wherein γ=2.

9. The online deep learning method according to claim 6, wherein the memristor-based computing-in-memory system further comprises an auxiliary computing unit for performing vector operations, and
during the back-propagation process of the online deep learning method, the calculation of the weight gradient is completed by the auxiliary computing unit.

10. The online deep learning method according to claim 6, wherein the memristor-based computing-in-memory system further comprises: a global buffer, and
during the back-propagation process of the online deep learning method, intermediate data required for the weight gradient calculation is stored in the global buffer.
